(19) United States
(12) Patent Application Publication
(10) Pub. No.: US 2026/0054466 A1
(43) Pub. Date: Feb. 26, 2026

(54) SURFACE COVERING WITH MAGNETIC COUPLING ARRANGEMENT

(71) Applicant: Hyperform, Inc., Rockledge, FL (US)

(72) Inventor: Jeffery Schieman, Indian Harbor Beach, FL (US)

(21) Appl. No.: 19/006,351

(22) Filed: Dec. 31, 2024

Related U.S. Application Data
(63) Continuation of application No. 18/811,015, filed on Aug. 21, 2024.

(51) Int. Cl. B32B 3/18; B32B 3/30; B32B 5/18; B32B 5/32; B32B 25/04; B32B 27/06; B32B 27/36; B63B 17/00

(52) U.S. Cl. CPC B32B 3/18; B32B 3/30; B32B 5/18; B32B 5/32; B32B 25/045; B32B 27/065; B32B 27/36; B63B 17/00; B32B 2272/00; B32B 2307/208; B32B 2307/5825; B32B 2471/04; B32B 2605/12

(57) ABSTRACT

A cover mat includes first and second layers each having an upper surface and a bottom surface and each comprising a foam material, the second layer attached to the first layer, the second layer configured to be supported by a support surface that is separate from the cover mat, wherein a preformed relief extends into at least one of the first layer and the second layer, and a magnet located within the preformed relief and between the first layer and the second layer such that the magnet is completely encapsulated between the first layer and the second layer, and wherein the magnet is configured to secure a ferromagnetic article to the cover mat.

### CROSS-REFERENCE TO RELATED APPLICATIONS

This application is a continuation of U.S. patent application Ser. No. 18/811,015, filed Aug. 21, 2024, entitled “SURFACE COVERING WITH MAGNETIC COUPLING ARRANGEMENT,” which claims priority to U.S. Provisional Ser. No. 63/643,057 , filed May 6, 2024, entitled “SURFACE COVERING WITH MAGNETIC COUPLING ARRANGEMENT,” the entire disclosures of which are incorporated herein by reference

### BACKGROUND OF THE INVENTION

The embodiments as described and shown herein relate generally to floor mat arrangements and surface covers, and particularly to floor mat arrangements and surface covers that utilize coupling arrangements that include embedded magnets and/or ferromagnetic materials to unobtrusively secure the mats and covers to supporting surfaces of various vehicles including marine vehicles and to couple various articles to the mats, and methods relating thereto while preventing deterioration to the coupling arrangements due to the harsh use environments.

### BRIEF SUMMARY OF THE INVENTION

One embodiment as shown and described herein may include a cover mat that includes a first layer having an exposed first upper surface and a first bottom surface opposite the first upper surface, wherein the first layer comprises a first foam material, a second layer having a second upper surface facing the first bottom surface and a second bottom surface opposite the second upper surface, wherein the second upper surface is attached to the first bottom surface, the second bottom surface is configured to be supported by a support surface that is separate from the cover mat, and wherein the second layer comprises a second foam material, wherein a preformed relief extends into at least one of the first bottom surface of the first layer and the second upper surface of the second layer, and a magnet located within the preformed relief and between the first layer and the second layer such that the magnet is completely encapsulated between the first layer and the second layer, and wherein the magnet is configured to secure a ferromagnetic article to the cover mat.

Another embodiments as shown and described herein may further or alternatively include a cover mat arrangement that includes a first foam layer having an exposed first upper surface and a first bottom surface opposite the first upper surface, wherein the first layer comprises at least one of an EVA foam, a PE foam and an EPDM foam, a second foam layer having a second upper surface facing the first bottom surface and a second bottom surface opposite the second upper surface, wherein the second foam layer comprises at least one of an EVA foam, a PE foam and an EPDM foam, wherein the second upper surface is attached to the first bottom surface, the second bottom surface is secured directly to a support surface via an adhesive where the support surface is separate from the first and second foam layers prior to the second foam layer being secured to the support structure via the adhesive that is separate from the floor mat, wherein a plurality of preformed reliefs extend into the second upper surface of the second foam layer, and a plurality of magnets located within the plurality of preformed reliefs and between the first foam layer and the second foam layer such that the plurality of magnets are completely encapsulated between the first foam layer and the second foam layer, wherein a location of the plurality of magnets with respect to the first and second foam layers is preselectively determined, and wherein the magnets are configured to secure one or more ferromagnetic articles to the cover mat arrangement.

The inventive marine mat and associated method provide a marine surface covering that improves user safety and comfort while allowing for easy and repeated removal and reinstallation of the mat for cleaning of the supporting and surrounding surfaces and/or access to underlying maintenance or storage compartments. The inventive floor covering further provides a highly wear resistant comfort surface which is further protected from corrosion and deterioration from harsh use environments and is particularly well suited for use in both fresh water and salt water environments.

These and other features, advantages, and objects of the embodiments disclosed herein will be further understood and appreciated by those skilled in the art by reference to the following specification, claims, and appended drawings.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating the preferred embodiments of the invention and are not to be construed as limiting the invention. In the drawings:

FIG. 1 is a perspective view of marine floor mat arrangements attached to and supported by various surfaces of an associated boat;

FIG. 2 is a cross-sectional top plan view of the marine floor mat arrangements and various support surfaces taken along the line II-II, FIG. 1;

FIG. 3 is a top plan view of a marine floor mat;

FIG. 4 is a cross-sectional side elevation view of the marine floor mat of FIG. 3 taken along line IV-IV, FIG. 3;

FIG. 5 is a cross-sectional side elevation view of an alternative embodiment of the marine floor mat;

FIG. 6 is a cross-sectional side elevation view of another alternative embodiment of the marine floor mat;

FIG. 7 is a cross-sectional side elevation view of another alternative embodiment of the marine floor mat;

FIG. 8 is a cross-sectional side elevation view of another alternative embodiment of the marine floor mat; and

FIG. 9 is a cross-sectional side elevation view of another alternative embodiment of the marine floor mat.

### DETAILED DESCRIPTION OF THE INVENTION

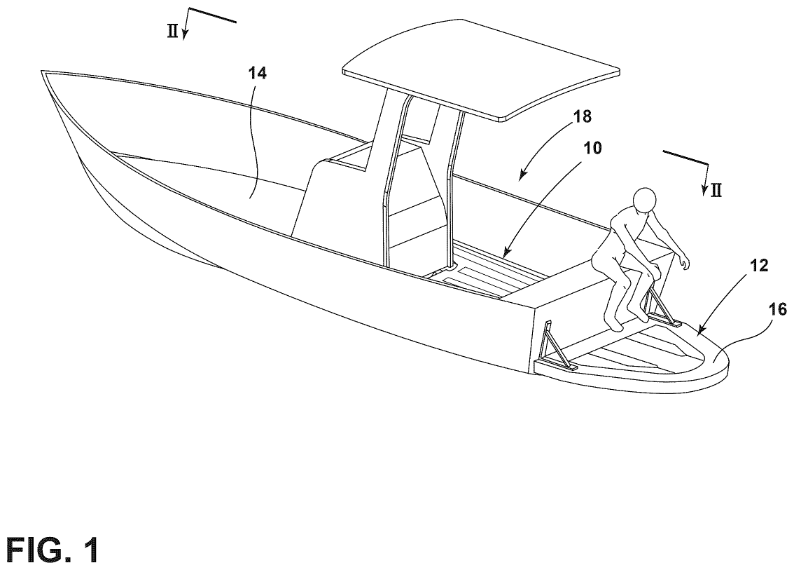

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other characteristics relating to the embodiments disclosed herein are not to be considered as limiting, unless the claims expressly state otherwise.

As used herein, “EVA” includes within its meaning ethylene-vinyl acetate. In embodiments, EVA material may be in sheet form. As used herein “PE” includes within its meaning polyethylene. In embodiments, PE material may be in sheet form. As used herein, “EPDM” includes within its meaning ethylene propylene diene monomer rubber, and any type of synthetic rubber. In embodiments, EPDM material may be in sheet form.

As used herein, “non-skid surface covering” or “surface covering” includes within their meanings EVA and PE foam materials, which may be in sheet form, and EPDM. “Non-skid surface covering” or “surface covering” also include within their meanings a multi-sheet structure that may be comprised of any number of sheets of EVA foam, PE foam or EPDM, in any combination.

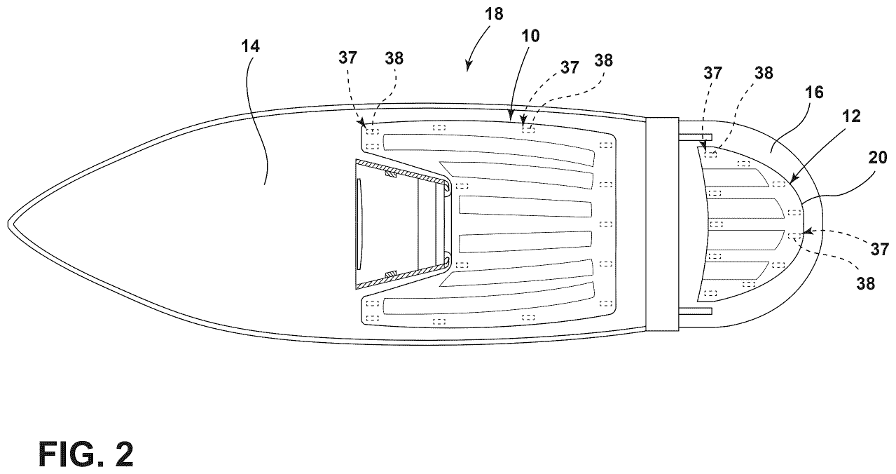

With initial reference to FIG. 1, the reference numeral 10 generally designates a deck cover or mat while the reference numeral 12 generally designates a swim platform cover or mat each embodying the present invention. While the various embodiments and examples described herein include mats associated with or attached to marine vehicles, the various embodiments may also be utilized with other vehicles, including but not limited to, passenger vehicles such as cars and trucks, commercial land vehicles, recreational vehicles, golf carts, ATVs, UTVs, and the like, as well as other objects like coolers, benches and other seating arrangements, and the like. Further, where applicable, the embodiments as described herein may also be utilized to couple articles and items to the mat, particularly to an outer, exposed surface of the mat. In certain embodiments, the mat may be secured to a supporting structure via an adhesive, particularly a pressure sensitive adhesive, and various articles coupled to the mat via the one or more associated magnets. In the illustrated examples, the mats 10, 12 are shown covering and attached to a deck surface 14 and a swim deck surface 16 of a marine vehicle such as a boat 18, respectively. As best illustrated in FIG. 2, each mat is provided a non-quadrilateral outer peripheral shape in plan view that substantially matches or complements a shape of the deck surface 14 and swim deck surface 16. While the illustrated examples have particular outer peripheral shapes, the mats and covers as described herein are configured to allow coverage of surface areas of varying shapes and sizes as well as to allow coupling of the mats and covers to structural elements of the boat 18, as described below.

As the deck cover or mat 10 and the swim platform cover or mat 12 are similarly constructed, only the swim platform and cover or mat 12 is described herein. In the illustrated example, the mat 12 (FIGS. 2-4) is provided with a peripheral edge 20 that has a non-quadrilateral plan outer shape that complements or substantially matches the overall shape of the swim deck surface 16. As noted above, the overall shape of the peripheral edge 20 may be configured to match surfaces upon which the mat 12 is supported, including wrapping about portions of the deck or boat or components of the marine vehicle such that the mat 12 can cover a majority of or substantially all of the supporting surface.

In the illustrated example, the mat 12 includes a first or upper layer 22 having a top or outer surface 24 and a bottom or inner surface 26, and a second or lower layer 28 having a top or inner surface 30 and a bottom surface 32 configured to abut the swim deck surface 16 of the associated swim deck 34. The upper layer 22 and the lower layer 28 may each comprise or are made from EVA foam, PE foam, and/or EPDM foam and may be provided as a single piece or a plurality of complimentary pieces covering the overall plan form of the surface to be covered. The upper and lower layers 22, 28 may either partially or entirely comprise recycled materials,. In some instances, the lower layer 28 may comprise a rubber material, either recycled or virgin. The general overall peripheral shape of the piece or pieces that comprise the first layer 22 and/or the second layer 28 may be provided via molding, routing, laser cutting, water cutting, and the like. For example, as best illustrated in FIG. 3, the lower layer 28 is provided as an integral, single-piece that covers the entire area covered by the mat 12, while the upper layer 22 is provided as a plurality of individual pieces with channels 36 extending therebetween. The channels 36 may be formed by the spacing various pieces of the upper layer 22 or may be formed via routing or other appropriate machining process. The upper layer 22 may be attached or secured to the lower layer 28 via chemical bonding, adhesives such as pressure adhesives, sonic welding, and/or formed via a roll lamination process. The top or outer surface 24 of the upper layer 22 provides a slip-resistant surface, and may be provided with a textured surface or pattern so as to improve the slip-resistant characteristics thereof.

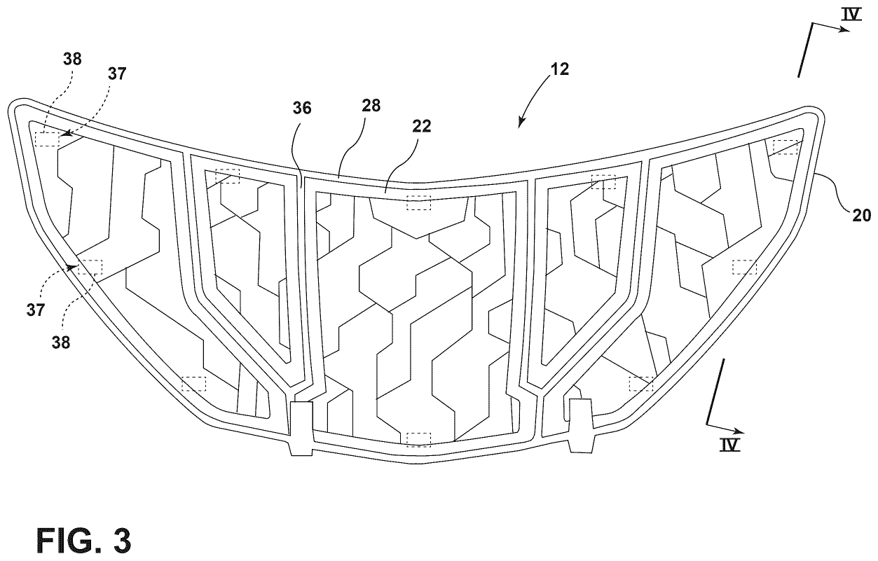

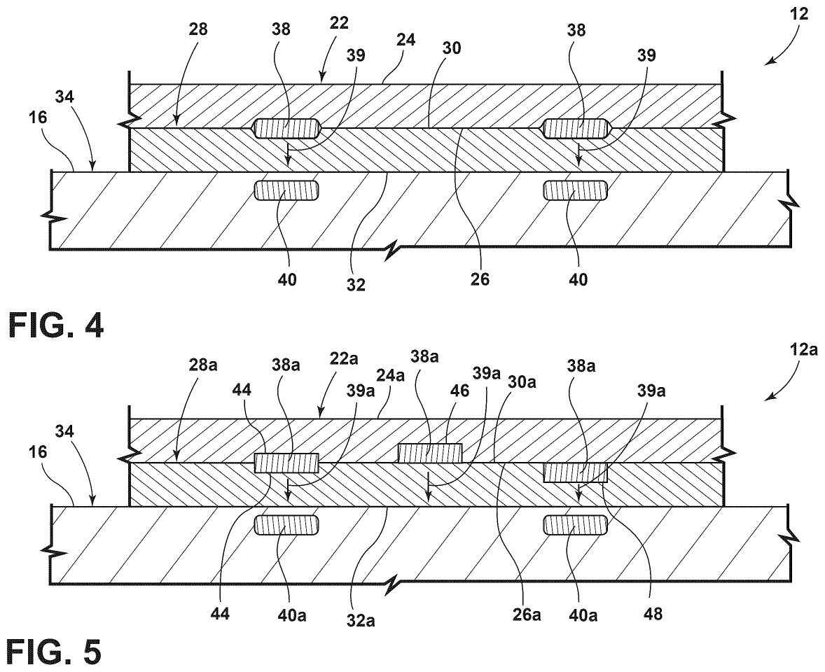

The mat 12 further includes a plurality of non-contact coupler arrangements 37 which in the illustrated examples include a plurality of magnets 38 positioned between the upper layer 22 and the lower layer 28, where the magnetic north of magnet 38 faces in an inward or downward direction 39. In the illustrated example, the magnets 28 are placed at pre-selectively determined positions with respect to the upper layer 22 and the lower layer 28 so as to substantially match positions of ferromagnetic connection members 40 attached to the swim deck 34. The ferromagnetic connection members 40 may be separate from the swim deck 34 and attached to the outer surface 16 of the swim deck 34 or attached to the swim deck 34 by being integrally formed therein, such as the example illustrated in FIG. 4, and such that the ferromagnetic connection members 40 are completely encapsulated within the swim deck 34 so as to prevent environmental degradation thereof, such as rusting or corrosion. The magnets 38 may be secured to one of the bottom surface 26 of the upper layer 22 or the top surface 30 of the lower layer 28 prior to the upper layer 22 and the lower layer 28 being attached to one another. Preferably, the upper layer 22 and the lower layer 28 are attached to one another such that the magnets 38 are completely encased between the upper layer 22 and the lower layer 28 thereby preventing corrosion to the magnets 38. In other embodiments, the magnets 38 may be attached to or embedded within the swim deck 34 with the ferromagnetic connection members 40 being secured between the upper layer 22 and the lower layer 28, or combinations thereof. As noted above, the ferromagnetic connection members 40 may be embedded within the swim deck 34. The ferromagnetic connection members 40 may be separate members dedicated to coupling with the magnets 38 to secure the mat 12 to the swim deck surface 16 or may include structural members and separate mechanical pieces of the overall structure of the boat 18. The non-contact coupling arrangement 37 as described allows for an unobtrusive connection of the mat 12 to the swim deck 34 without requiring separate mechanical fasteners to be used within and potentially destroy the swim deck surface 16. The magnetic coupling arrangement further allows easy removal of the mat 12 for cleaning the associated surface 16 or attending to other maintenance processes that require access to the swim deck surface 16. The placement or location of the magnets relative to the overall plan form of the mat 12 may be determined to use the location of the pre-existing structural members of the boat 18.

In an alternative embodiment, a mat 12a (FIG. 5) is constructed similarly to the mat 12, such that the same reference numerals are used for the corresponding elements as shown in FIGS. 3 and 4 and FIG. 5, except with the suffix “a” used in the numerals of the latter. In the illustrated example, the magnets 38a are located within recesses routed within the inner surface 26a of the upper layer 22a and/or the inner surface 30a of the lower layer 28a. For example, the magnets 38a may be inserted into cooperating and aligned recesses 44 formed in both the upper layer 22 and the lower layer 28, recesses 46 formed within the upper layer 22 and recesses 48 formed within the lower layer 28. The magnets 38a may be held in position within the corresponding recesses 44, 46, 48 via an adhesive which may be located exclusively within the recesses 44, 46, 48 or across the entire inner surface 26a and/or inner surface 30a. The location of the recesses 44, 46, 48 are preselected so as to require locating of the magnets 38a in locations that will align with the cooperating ferromagnetic connection members 40a when the mat 12 is located on the swim deck surface 16. In various embodiments, the upper layer 22, 22a, 22b and the lower layer 28, 28a, 28b may be provided at various preferred thicknesses. For example, the upper layer 22, 22a, 22b and the lower layer 28, 28a, 28b may each have a thickness of about 5 mm such that the mat 12, 12a, 12b has an overall thickness of about 10 mm. Alternatively, the upper layer 22, 22a, 22b may have a thickness of either 3 mm or 5 mm while the lower layer 28, 28a, 28b has a thickness of either 5 mm or 3 mm, or vice versa, although the upper layer 22, 22a, 22b and the lower layer 28, 28a, 28b may both have a thickness of about 3 mm.

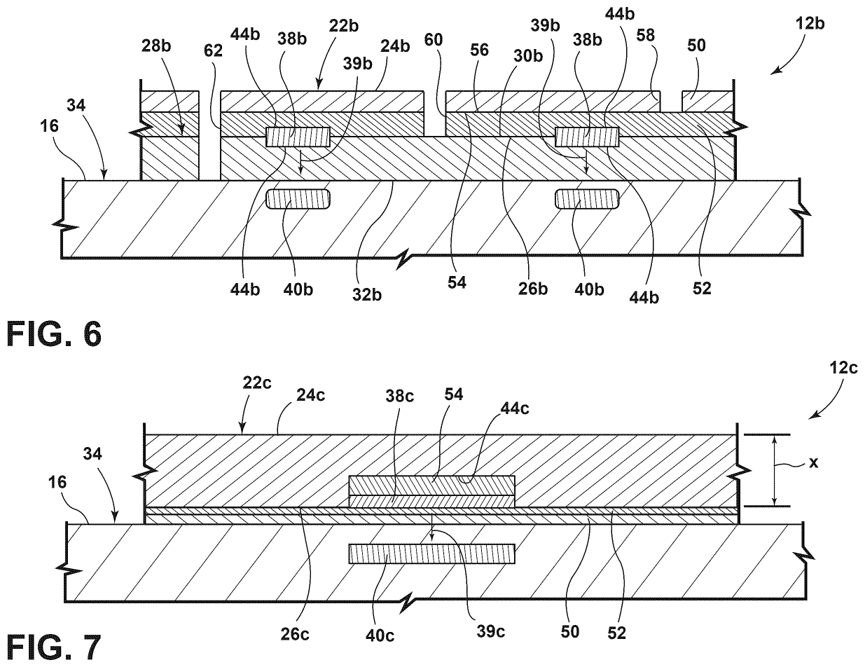

In another alternative embodiment, the upper layer 22b (FIG. 6) includes a first sublayer 50 and a second sublayer 52 where the first sublayer 50 includes the outer surface 24b and an inner surface 54 while the second sublayer 52 includes the inner surface 26b and an inner surface 56. As the mat 12b is similar to the mat 12, similar elements appearing in FIG. 6 utilize the same reference numerals as corresponding elements in FIG. 4 except for the suffix “b” in the numerals of the latter. In the illustrated example, the mat 12b may include channels 58 that extend through the first sublayer 50 only, channels 60 that extend through both the first sublayer 50 and the second sublayer 52, and channels 62 that extend entirely through the mat 12b including the upper layer 22b and the lower layer 28b. In the embodiment as illustrated the various layers may be provided with different characteristics, such as different foam compositions including weight and densities, and varying colors, thereby allowing various differing visual patterns to be provided. For example, the first sublayer 50 may be provided as a first color while the second sublayer 52 may be provided as a second color and the lower layer 28b may be provided in a third color such that various combinations of the channels 58, 60, 62 may be utilized to show various color patterns or textures depending upon the construction of the various layers and the depth of the channels.

In yet another embodiment, a mat 12c (FIG. 7) may include the layer 22c and a reinforcement layer 50. As the mat 12c is similar to the previously described mat 12, the same reference numerals are used for the corresponding elements as shown in FIG. 4 and FIG. 7, except for the suffix “c” used in the numerals of the latter. Although shown with a single layer of foam, namely layer 22c, multiple layers of foam may be utilized similar to the embodiments illustrated in FIGS. 4-6 and as described above. In the illustrated example, the layer 22c has a thickness x of approximately 10 mm. Alternatively, two foam layers each having a thickness of approximately 5 mm each could be utilized. The reinforcement layer 50 provides an increased structural integrity to the overall mat 12c to prevent tearing or ripping of the mat 12c during use and when the mat 12c is attached to and removed from coupling with the surface 16. The reinforcement layer 50 may comprise Mylar® or similar material. In the illustrated example, the reinforcement layer 50 is attached to the bottom surface 26c of layer 22c via a pressure sensitive adhesive 52 located therebetween. The mat 12c further includes a metal backing member 54 located with the magnet 38c within the recess 44c.

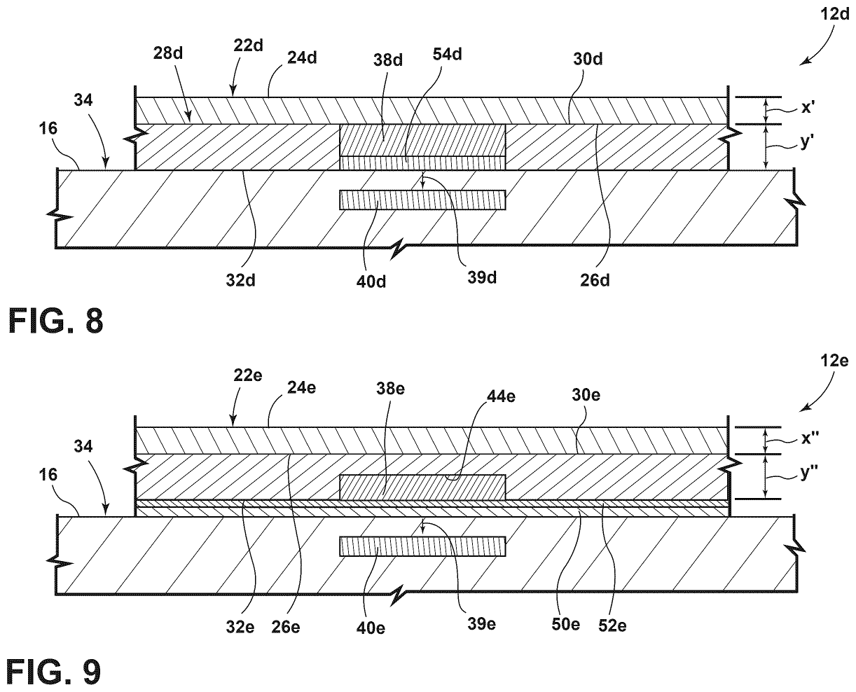

In another embodiment, a mat 12d (FIG. 8) may include the upper layer 22d and the lower layer 28d, the magnet 38d and the metal blank 54d. As the mat 12d is similar to the previously described mat 12, the same reference numerals are used for the corresponding elements as shown in FIG. 4 and FIG. 8 except for the suffix “d” in the numerals of the latter. In the illustrated example, the upper layer 22d is provided a thickness of x′ of approximately 3 mm while the lower foam layer 28d is provided with a thickness y′ of approximately 5 mm. It is noted that the combined thickness of the magnet 38d and the metal blank 54d may approximately equal the thickness y′ of the lower layer 28d such that the magnet 38d and the metal blank 54d extend entirely between the inner surface 26d of the upper layer 22d and the bottom surface 32d of the lower layer 28d. Alternatively, the magnet 38d may itself have a thickness that extends entirely between the inner surface 26d of the upper layer 22d and the bottom surface 32d of the lower layer 28d. The metal blank 54d may be coated with a rust inhibiting coating.

In still another alternative embodiment, the mat 12e may include the upper layer 22e, the lower layer 28e, and the reinforcement layer 50e attached to the lower layer 28e via the adhesive layer 52e. In the illustrated example, the magnet 38e is received with the corresponding recess 44e, with the reinforcement layer 50e cooperating with the bottom layer 28e to completely encapsulate the magnet 38e thereby preventing corrosion of the magnet 38e. The reinforcement layer 50e may include Mylar® or may alternatively include a rubber material. Preferably the upper layer 22e has a thickness x″ of about 3 mm while the lower layer 28e has a thickness y″ of about 5 mm.

The above description is considered that of the preferred embodiment(s) only. Modifications of the invention will occur to those skilled in the art and to those who make or use the invention. Therefore, it is understood that the embodiment(s) shown in the drawings and described above is/are merely for illustrative purposes and not intended to limit the scope of the invention, which is defined by the following claims as interpreted according to the principles of patent law, including the doctrine of equivalents.

1. A cover mat, comprising:
a first layer having an exposed first upper surface and a first bottom surface opposite the first upper surface, wherein the first layer comprises a first foam material;
a second layer having a second upper surface facing the first bottom surface and a second bottom surface opposite the second upper surface, wherein the second upper surface is attached to the first bottom surface, the second bottom surface is configured to be supported by a support surface that is separate from the cover mat, and wherein the second layer comprises a second foam material, wherein a preformed relief extends into at least one of the first bottom surface of the first layer and the second upper surface of the second layer; and
a magnet located within the preformed relief and between the first layer and the second layer such that the magnet is completely encapsulated between the first layer and the second layer, and wherein the magnet is configured to secure a ferromagnetic article to the cover mat.

2. The cover mat of claim 1, wherein the preformed relief is one of a plurality of reliefs and the magnet is one of a plurality of magnets.

3. The cover mat of claim 1, wherein the first foam material comprises at least one of an EVA foam, a PE foam and an EPDM foam.

4. The cover mat of claim 1, wherein the second foam material comprises at least one of an EVA foam, a PE foam and an EPDM foam.

5. The cover mat of claim 1, wherein the first layer and second layer each comprise the same type of foam.

6. The cover mat of claim 1, wherein the floor mat comprises a non-quadrilateral outer shape in top plan view.

7. The cover mat of claim 1, wherein the second upper surface of the second layer is adhered to the first bottom surface of the first layer via an adhesive.

8. The cover mat of claim 1, wherein the cover mat is a unitary, single piece.

9. The cover mat of claim 1, wherein the preformed relief is located entirely within the second layer.

10. The cover mat of claim 1, wherein the preformed relief is routed into the at least one of the first bottom surface of the first layer and the second upper surface of the second layer.

11. The cover mat of claim 1, wherein the second bottom surface of the second layer is configured to directly abut the support surface.

12. A cover mat arrangement, comprising:
the cover mat of claim 1 attached to the separate support surface via an adhesive.

13. The cover mat arrangement of claim 12, further comprising:
a boat that includes the separate support surface.

14. A cover mat arrangement, comprising:
a first foam layer having an exposed first upper surface and a first bottom surface opposite the first upper surface, wherein the first layer comprises at least one of an EVA foam, a PE foam and an EPDM foam;
a second foam layer having a second upper surface facing the first bottom surface and a second bottom surface opposite the second upper surface, wherein the second foam layer comprises at least one of an EVA foam, a PE foam and an EPDM foam, wherein the second upper surface is attached to the first bottom surface, the second bottom surface is secured directly to a support surface via an adhesive where the support surface is separate from the first and second foam layers prior to the second layer being secured to the support structure via the adhesive, wherein a plurality of preformed reliefs extend into the second upper surface of the second layer; and
a plurality of magnets located within the plurality of preformed reliefs and between the first foam layer and the second foam layer such that the plurality of magnets are completely encapsulated between the first foam layer and the second foam layer, wherein a location of the plurality of magnets with respect to the first and second foam layers is preselectively determined, and wherein the magnets are configured to secure one or more ferromagnetic articles to the cover mat arrangement.

15. The cover mat arrangement of claim 14, wherein the support structure includes a boat deck.

16. The cover mat arrangement of claim 14, wherein the first and second foam layers each comprise a non-quadrilateral plan outer shape in top plan view.

17. The cover mat arrangement of claim 14, wherein the first foam layer is attached to the second foam layer via an adhesive.

18. The cover mat arrangement of claim 14, wherein the plurality of reliefs are routed in the second upper surface of the second foam layer.

19. The cover mat arrangement of claim 14, wherein the first and second foam layers comprise the same type of foam.

20. The cover mat arrangement of claim 14, wherein the reliefs are routed in the first bottom surface of the first foam layer.

21. The cover mat of claim 1, wherein the first layer includes a channel extending into the exposed first upper surface and at least partially between the exposed first upper surface and the first bottom surface.

22. The cover mat of claim 21, wherein the channel extends entirely between the exposed first upper surface and the first bottom surface such that the second layer is visible through the channel.

23. The cover mat arrangement of claim 14, wherein the first foam layer includes a channel extending in the exposed first upper surface and at least partially between the exposed first upper surface and the first bottom surface.

24. The cover mat arrangement of claim 23, wherein the channel extends entirely between the exposed first upper surface and the first bottom surface such that the second foam layer is visible through the channel.
